(19) United States
(12) Patent Application Publication
(10) Pub. No.: US 2003/0224223 A1
(43) Pub. Date: Dec. 4, 2003

(54) Battery pack electronics assembly

(75) Inventor: Malcolm John Edwards, Hoehenkurchen (DE)

Correspondence Address: GEORGE O. SAILE & ASSOCIATES, 28 DAVIS AVENUE, POUGHKEEPSIE, NY, 12603, US

(73) Assignee: Dialog Semiconductor GmbH

(21) Appl. No.: 10/163,666

(22) Filed: Jun. 6, 2002

(30) Foreign Application Priority Data
Jun. 3, 2002 (EP) 02368055.6

(51) Int. Cl. H01M 10/46; H01M 2/02; H01M 10/04

(52) U.S. Cl. 429/7; 429/127; 429/176; 429/149; 29/623.1

(57) ABSTRACT

A removable battery package incorporating electronic functions and a method to assemble said battery package is achieved. The battery package comprises one or more rigid or flexible battery cells of various shape and a smart card being wrapped around said battery cells to form an inside housing of the battery package casing. Said smart card could have customised dimensions to suit the battery cell and battery pack dimensions and could have the external connections on one side or on both sides. A cold welding process is possible to provide the connections from the battery tabs to said smart card.

### BACKGROUND OF THE INVENTION

(1) Field of the Invention

This invention relates generally to a battery assembly, and more particularly to an assembly technique to incorporate electronic functions within removable battery packs.

(2) Description of the Prior Art

The popularity of portable electronic devices has led to a huge increase in the usage of battery packs. Many of these applications require removable battery packs. Sometimes the battery chemistry used requires electronics to make it safe. Also sophisticated electronic monitoring and control functions communicating between the battery and said electronic device are incorporated within the battery pack. Usually the bare battery cells have to be mounted together with any required electronics into a sealed housing with exposed electrical contacts to connect the pack to the electronic device using it.

Any electronics incorporated in the battery pack add to the total pack cost. Today this represents a significant part of the total pack costs. Furthermore it also adds to the total volumetric size of the completed pack.

Smart cards are the worlds largest single market for electronic devices. Specialised, highly automated, assembly machines have been developed to make them very cost effective. The basic card is a 0.4-0.6 mm thick semi-rigid plastic material with exposed gold plated contacts and electronic components embedded within the card.

Semiconductor die are pre-assembled onto reeled lead-frames, singulated, and then mounted into the plastic card. It is today also possible to mount additional electronic components within the same assembly.

Bare battery cells are manufactured in various shapes. The most popular shapes are cylindrical and rectangular (prismatic). It is very common that the terminals are flat metal tabs at opposite ends of the cell. The tabs are usually cold-welded to the cell and are used to connect the cell to the electronics and the external pack connections. It is generally not allowed to use any heat process when connecting the cell connection tabs to the electronics as the heat could damage the cell. Usually a cold welding process is used. FIG. 1 prior art shows a typical prismatic battery cell 1 with metal connection tabs 2 welded to the casing (the hidden end also has a similar tab attached which is concealed in the drawing).

U.S. Pat. No. (5,498,903 to Dixon et al.) describes an integrated circuit package of the surface-mountable type within which a battery is mounted. Battery leads extend from the side of the package body opposite that which is adjacent the circuit board when mounted, and between which a conventional battery may be placed. A gap is present between the housing and the battery. The gaps thermally insulate the battery from the package body and housing, so that the circuit may be subjected to solder reflow mounting to a circuit board, while insulating the high temperature from the battery.

U.S. Pat. No. (6,109,530 to Larson et al.) discloses a chip-battery micro-module and fabrication there of wherein an integrated circuit “chip” is secured to a battery coin cell using various conductive and insulating layers that provide power to the chip. The chip-battery micro-module may be used to power an electronic accessory that is directly attached thereto, such as an LCD display or speaker, or to power a circuit in a smart card or electronic device such as a portable phone. The chip battery micro-module can be integrated into a plastic smart card.

U.S. Pat. No. (6,284,406 B1 to Xing et al) shows an IC card comprising an electronic device and a battery within a plastic card for electrically energizing the electronic device. The battery is comprised as a monolithic electro-chemical cell having a lithium-containing cathode, a carbon anode, and a porous polymer separator infused with electrolyte solution. The cell has a thickness of less than 0.7 mm. The battery has an overall thickness of less than 0.8 mm.

### SUMMARY OF THE INVENTION

A principal object of the present invention is to provide a battery package to incorporate electronic functions.

A further object of the present invention is to use proven low-cost assembly techniques to build a battery package incorporating electronic functions.

In accordance with the objects of this invention a battery package comprising a battery cell and an IC card comprising electronic circuitry, an area for battery tab contacts and external connections has been achieved. Said IC card is wrapped around said battery cell forming the inside housing of the battery package casing and wherein said IC card is connected to the tabs of said battery cell.

In accordance with the objects of this invention a battery package comprising a rigid battery cell and an IC card comprising electronic circuitry, an area for battery tab contacts and external connections has been achieved. Said IC card is wrapped around said rigid battery cell forming the inside housing of the battery package casing and wherein said IC card is connected to the tabs of said battery cell.

In accordance with the objects of this invention a battery package comprising a flexible battery cell and an IC card of any size required comprising electronic circuitry, an area for battery tab contacts and external connections has been achieved. Said IC card is connected to the tabs of said battery cell via flexible contacts.

In accordance with further objects of this invention a battery package comprising a rigid battery cell and a double-sided IC card comprising electronic circuitry having external contacts on both sides has been achieved. The external contacts providing connections to the battery cell are located on the face of said card nearest to the battery cell.

In accordance with further objects of the invention a method to assemble a battery package incorporating electronic functions providing a battery cell and a single sided IC card comprising electronic circuitry, an area for battery tab contacts and external connections has been achieved. Said method comprises as first step to mount circuitry and contacts on said IC card, followed by providing folds and slots for easier handling of said IC card. Additional steps are to wrap said IC card around said battery cell and to establish electrical connections between said IC card and said battery cell.

### BRIEF DESCRIPTION OF THE DRAWINGS

In the accompanying drawings forming a material part of this description, there is shown:

FIG. 1 prior art illustrates a typical prismatic battery cell with connection cells

FIG. 2 shows an electronic assembly on a battery card

FIG. 3 shows a battery cell connection to a battery card

FIG. 4A shows a battery card on the visible card face.

FIG. 4B Shows a battery card on the card face close to the battery cell.

FIG. 4C shows a battery connection to a double-sided card.

FIG. 5 illustrates how a flexible battery cell is connected to a battery card.

FIG. 6 shows a flowchart of the method illustrating an assembly process of a battery pack using a single-sided IC card

FIG. 7 shows a flowchart of the method illustrating an assembly process of a battery pack using a double-sided IC card.

### DESCRIPTION OF THE PREFERRED EMBODIMENTS

The preferred embodiments disclose a smart card or a “battery card” to be assembled combined with one or more battery cells to a battery package and a method how to assemble said battery package.

In order to distinguish this new smart card usage it will be referred to as a battery card in this document.

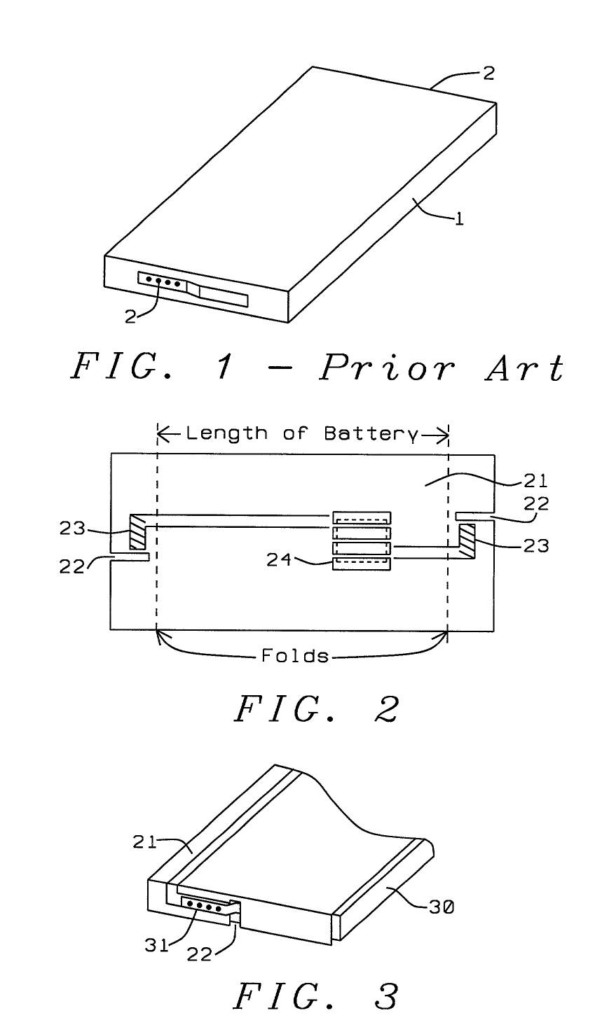

Various shapes and forms of construction are possible for the battery card. A typical smart card has always industry standard dimensions while the shape and the form of a battery card have to match with the shape and the form of the battery cells used in the battery pack. The battery card has customised dimensions to suit the dimensions of the cell and or of the battery pack. One example is shown in FIG. 2 where the battery card is dimensioned to lie flat over the battery and to fold the narrow ends over the tab ends of the battery. 21 represents the battery card. The areas for the battery tab connection at both ends of the card and the connection contacts 24 to the circuitry on the battery card are signified by 23. The dotted lines show where the card is folded over one or more battery cells. The distance between the both folds corresponds to the length of the battery. The battery card can be used to monitor the temperature of the battery cell as well. Since the battery card contacts the battery cell the circuitry on the battery card can measure the temperature of the cell and transmit this information via the external contacts 24 to a charger.

The slots 22 in the card would allow the battery connection tabs to protrude through the card so that the tabs could be welded to the card. FIG. 3 shows an example of a rigid prismatic battery cell used as e.g. a Li-Ion cell. FIG. 3 shows how the battery card 21 is folded over said rigid battery and how the battery cell is connected to the battery card. The connection tab 31 welded to the battery card is shown beside said slot 22 of the battery card. Said connection card serves to electrically connect the cell to the battery card. Any product labelling could be printed on the visible card side.

A further example of a battery card construction is a card with external connections on both sides. Thus the external connections providing power and/or communications to the portable external device would be on the card face furthest from the battery cell and on the face next to the battery the cell connections would be placed. Such a card construction could also form the inside housing of the battery pack casing. This would additionally reduce battery pack costs. Any product labelling could also be printed on the visible card side the same way as with single sided battery cards.

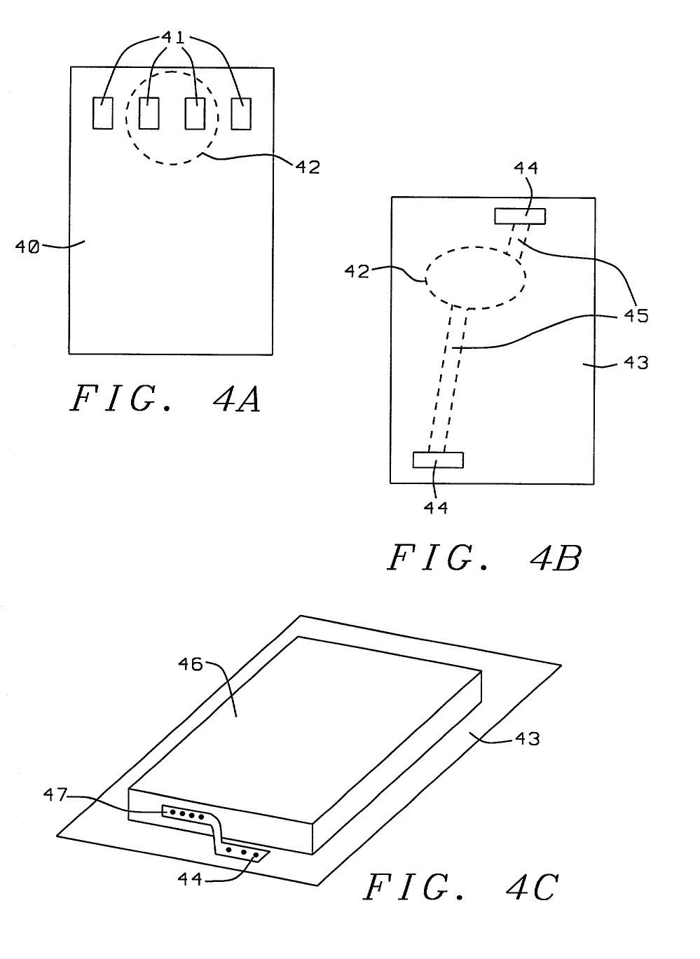

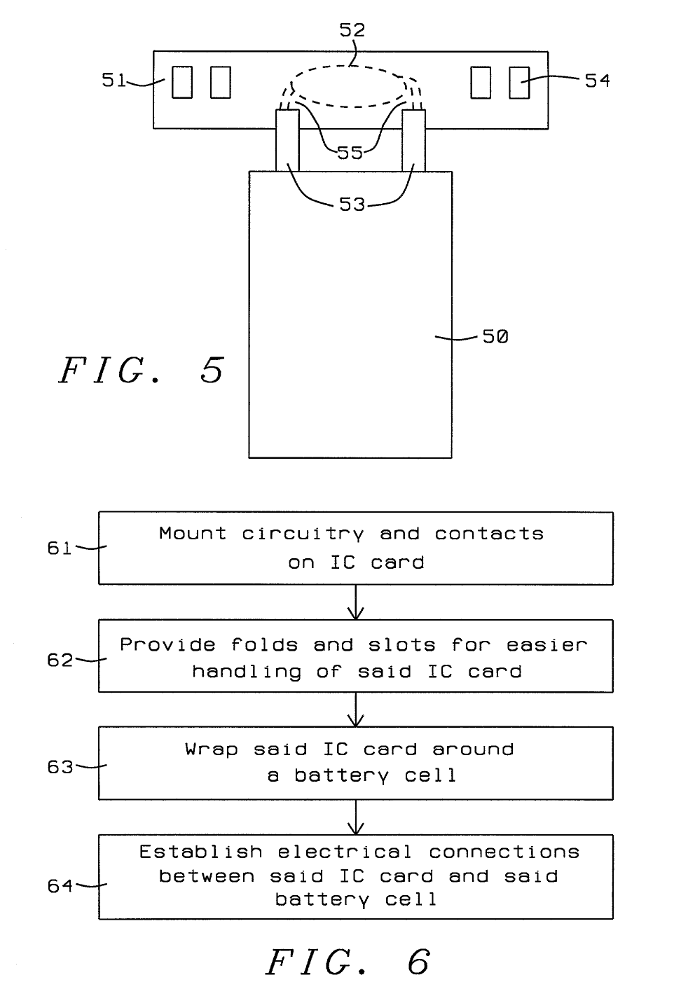

FIGS. 4A, B and C illustrate the usage of such a double-sided battery card together with a rigid battery as shown in FIG. 3. FIG. 4A shows the side of such a double-sided battery card, that is furthest from the battery cell 40. It is called side A in this document. The external contacts of the side A 40 of said double sided battery card to a portable electronic device as a mobile phone, palm top computer, etc. are signified by the number 41. The dotted line 42 signifies the electronic circuitry buried in the battery card.

FIG. 4B shows the side of said double-sided battery card that is next to said rigid battery cell, signified by 43. It is called side B in this document. The area circled by the dotted line 42 signifies the buried electronic circuitry. The battery connections 44 are shown at the top and at the bottom of the side B. The dotted lines 45 signify the buried connections between the electronic circuitry 42 and the battery connections 44.

FIG. 4C shows said a rigid battery cell 46 and the connection between the side B 43 of said double-sided battery card and the battery cell in an unfolded state of said battery card. The battery card can be folded around the battery cell afterwards. The folding depends on the required shape of the final battery pack. The electrical connection between the battery cell and the battery card is performed by the connection tabs on the battery cell 47 and the connection tabs on the battery card 44. Same numbers are used for the same details of FIGS. 4A, B and C.

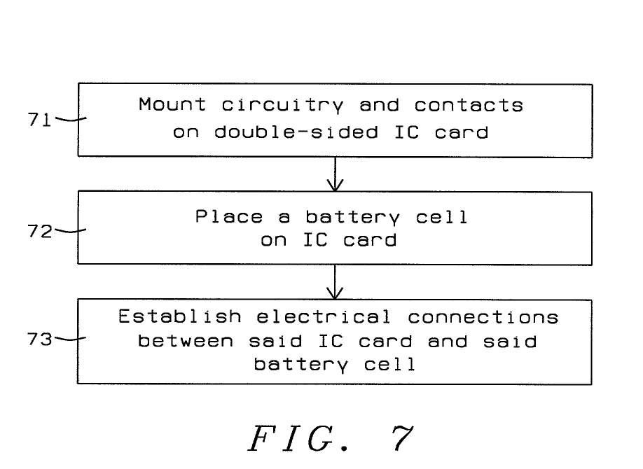

FIG. 5 illustrates the assembly of a flexible battery cell 50 as e.g. a Lithium Polymer cell with a battery card 51. The battery card could be single or double sided. The final positioning of the battery card in relation to the battery cell depends on where the external contacts are required to be.

The connections between the battery having flexible metal contacts 53 and the battery card 51 are cold-welded. The dotted line 52 illustrates the area of the buried electronic circuits. The external contacts to any portable device are signified by 54. The invisible electrical connections between the cold welded battery contacts 53 and said buried electronic circuitry 52 are made by the invisible conducting lines 55. The final positioning of the battery card in relation to the cell depends on where the external contacts are required to be located. They could be located e.g. on the end (flexible metal contacts 53 bent 90 degrees) or on the back of the assembled battery pack.

FIG. 6 illustrates a method how to assemble a battery pack comprising a single-sided battery card used as housing and one battery cell. The same steps can be used if more than one battery cells are being used. Step 61 describes that circuitry and contacts are mounted into said battery card. Step 62 describes that folds and slots are provided on the battery card for easier handling of said card. Step 63 describes that said battery card is wrapped around said battery cell. The last step 64 describes that that the electrical contacts are being established. A cold welding process is one alternative to establish said contacts.

FIG. 7 illustrates a method how to assemble a battery pack comprising a double-sided battery card. The folding and wrapping around process steps, as described in the steps 62 and 63, are not required using double-sided battery cards. Step 71 describes that circuitry and contacts are mounted on the double-sided card. In step 72 the battery cell is placed on the appropriate side of the battery card. It is possible to use more than one battery cells. The last step 73 describes that that the electrical contacts are being established. A cold welding process could be used as with single-sided cards.

While the invention has been particularly shown and described with reference to the preferred embodiments thereof, it will be understood by those skilled in the art that various changes in form and details may be made without departing from the spirit and scope of the invention.

What is claimed is:

1. A battery package comprising
a battery cell; and
an IC card comprising electronic circuitry, an area for battery tab contacts and external connections wherein said IC card is wrapped around said battery cell forming the inside housing of the battery package casing and wherein said IC card is connected to the tabs of said battery cell.

2. The battery package of claim 1 wherein the connections between the battery tabs and said battery tab contacts of said IC card are done by cold welding.

3. The battery package of claim 1 wherein slots in said IC card are provided to house the battery tabs after folding said IC card around said battery cell.

4. The battery package of claim 1 wherein folds in said IC card are provided to support the folding around the battery cell.

5. The battery package of claim 1 wherein product-labelling information is printed on the visible part of said IC card.

6. The battery package of claim 1 wherein the circuitry on said IC card is sensing the temperature of the battery cell and transmits this information via external contacts to a charger.

7. The battery package of claim 1 wherein more than one battery cells is being used.

8. A battery package comprising
a rigid battery cell; and
an IC card comprising electronic circuitry, an area for battery tab contacts and external connections wherein said IC card is wrapped around said rigid battery cell forming the inside housing of the battery package casing and wherein said IC card is connected to the tabs of said battery cell.

9. The battery package of claim 8 wherein the connections between the battery tabs and said battery tab contacts of said IC card are done by cold welding.

10. The battery package of claim 8 wherein slots in said IC card are provided to house the battery tabs after folding said IC card around said battery cell.

11. The battery package of claim 8 wherein folds in said IC card are provided to support the folding around the battery cell.

12. The battery package of claim 8 wherein product-labelling information is printed on the visible part of said IC card.

13. The battery package of claim 8 wherein the circuitry on said IC card is sensing the temperature of the battery cell and transmits this information via external contacts to a charger.

14. The battery package of claim 8 wherein more than one battery cells are being used

15. A battery package comprising:
a flexible battery cell; and
an IC card of any size required comprising electronic circuitry, an area for battery tab contacts and external connections wherein said IC card is connected to the tabs of said battery cell via flexible contacts.

16. The battery package of claim 15 wherein the connections between the battery tabs and said battery tab contacts of said IC card are done by cold welding.

17. The battery package of claim 15 wherein said flexible contacts are bent 90 degrees to enable the positioning of the external contacts on the end of the battery pack.

18. The battery package of claim 15 wherein the external contacts are on the back of the assembled battery pack.

19. The battery package of claim 15 wherein said IC card has the contacts towards the battery on one side and the external contacts on the other side.

20. The battery package of claim 15 wherein product-labelling information is printed on the visible part of said IC card.

21. The battery package of claim 15 wherein more than one flexible battery cells is being used.

22. A battery package comprising
a rigid battery cell; and
a double-sided IC card comprising electronic circuitry having external contacts on both sides, wherein the external contacts providing connections to the battery cell are located on the face of said card nearest to the battery cell.

23. The battery package of claim 22 wherein the connections between the battery tabs and said battery tab contacts of said IC card are done by cold welding.

24. The battery package of claim 22 wherein product-labelling information is printed on the visible part of said IC card.

25. The battery package of claim 22 wherein the circuitry on said IC card is sensing the temperature of the battery cell and transmits this information via external contacts to a charger.

26. The battery package of claim 22 wherein more than one battery cells is being used.

27. The battery package of claim 22 wherein slots in said IC card are provided to house the battery tabs after folding said IC card around said battery cell.

28. The battery package of claim 22 wherein folds in said IC card are provided to support the folding around the battery cell

29. A method to assemble a battery package incorporating electronic functions comprising:
providing a battery cell and a single sided IC card comprising electronic circuitry, an area for battery tab contacts and external connections;
mount circuitry and contacts on IC card;
provide folds and slots for easier handling of said IC card;
wrap said IC card around said battery cell; and
establish electrical connections between said IC card and said battery cell.

30. The method of claim 29 wherein a cold welding process is used to establish said electrical connections.

31. The method of claim 29 wherein more than one battery cells is being used.

32. A method to assemble a battery package incorporating electronic functions comprising:
providing a battery cell and a double-sided IC card comprising electronic circuitry, an area for battery tab contacts on one side and an area for external connections on the other side;
mount circuitry and contacts on IC card;
place said battery cell on IC card; and
establish electrical connections between said IC card and said battery cell.

33. The method of claim 32 wherein a cold welding process is used to establish said electrical connections.

34. The method of claim 32 wherein more than one battery cells is being used.
